(19) United States
(12) Patent Application Publication
(10) Pub. No.: US 2013/0341251 A1
(43) Pub. Date: Dec. 26, 2013

(54) FLOTATION DEVICE, METHOD FOR OPERATING THE FLOTATION DEVICE AND USE THEREOF

(71) Applicants: Stefan Blendinger, Furth (DE); Robert Fleck, Adelsdorf (DE); Gerold Franke, Nurnberg (DE); Lilla Grossmann, Erlangen (DE); Werner Hartmann, Weisendorf (DE); Wolfgang Krieglstein, Nurnberg (DE)

(72) Inventors: Stefan Blendinger, Furth (DE); Robert Fleck, Adelsdorf (DE); Gerold Franke, Nurnberg (DE); Lilla Grossmann, Erlangen (DE); Werner Hartmann, Weisendorf (DE); Wolfgang Krieglstein, Nurnberg (DE)

(21) Appl. No.: 14/002,778

(22) PCT Filed: Jan. 3, 2012
(86) PCT No.: PCT/EP2012/050048

§ 371 Date: Sep. 3, 2013

(30) Foreign Application Priority Data
Mar. 3, 2011 (DE) 102011005031.0

(51) Int. Cl. B03D 1/02; B03D 1/24

(52) U.S. Cl. CPC B03D 1/028; B03D 1/24
USPC 209/164; 209/170

(57) ABSTRACT

A flotation device for separating off a valuable mineral from a suspension, has a housing having a flotation chamber, a foam collector for removing a foam product formed in an upper region of the flotation chamber, a feed arrangement for feeding gas and/or suspension into the flotation chamber, an adjustable orifice via which the flotation chamber is horizontally divided into an upper part and a lower part and an open internal diameter of the flotation chamber is locally avoidable. The orifice is arranged completely in a suspension region of the flotation chamber. A measuring arrangement determines a variable in the operation of the flotation device. A control appliance connected to the arrangement automatically adjusts the orifice in dependence on the at least one state variable.

The invention relates to a flotation device for separating solid particles, particularly of a valuable mineral, from a suspension, comprising a housing having a flotation chamber, at least one foam collector for removing a foam product formed in an upper region of the flotation chamber, and at least one feed arrangement for feeding gas and/or suspension into the flotation chamber. The invention also relates to a method for operating such a flotation device and use thereof.

Flotation is a physical separation process for separating fine-grained mixtures of solids, e.g. ores and gangue, in an aqueous slurry or suspension using air bubbles, based on the different surface wettability of the particles contained in the suspension. It is used for the beneficiation of mineral resources and in the processing of preferably mineral substances containing low to average amounts of a wanted component or valuable material, e.g. in the form of nonferrous metals, iron, rare earth metals and/or noble metals, as well as nonmetallic mineral resources. However, the use of flotation is also generally well known in other technical fields such as waste water treatment, for example.

WO 2006/069995 A1 describes a flotation device in the form of a pneumatic flotation cell having a housing enclosing a flotation chamber, at least one nozzle arrangement, here termed ejectors, and also at least one gas-introducing device, referred to as aeration devices or aerators if air is used, and a collecting container for a foam product formed during flotation.

For pneumatic flotation, a reagentized suspension of water and fine-grained solid material is generally introduced into a flotation chamber via at least one nozzle arrangement. The reagents are designed to have the effect of hydrophobizing in particular the valuable particles, i.e. particles of useful material, preferably to be separated out from the suspension. Xanthates are mainly used as reagents, particularly in order to selectively hydrophobize sulfidic ore particles. Gas, in particular air, which comes into contact with the hydrophobic particles in the suspension is fed to the at least one nozzle arrangement simultaneously with the suspension. The hydrophobic particles adhere to gas bubbles forming, so that the gas bubble formations, also known as aeroflocs, float and form the foam product on the surface of the suspension. The foam product is discharged into a collecting container and usually further concentrated.

The quality of the foam product, i.e. the separation success of the flotation method, is dependent, among other things, on the probability of collision between a hydrophobic particle and a gas bubble. The higher the collision probability, the greater the number of hydrophobic particles attaching to a gas bubble, rising to the surface and forming the foam product together with the particles.

A preferred gas bubble diameter is less than about 5 mm and ranges in particular between 1 and 5 mm. Such small gas bubbles have a high specific surface and are therefore able to bind and entrain considerably more valuable material particles, particularly ore particles, per quantity of gas used than larger gas bubbles. Specific types of pneumatic flotation include dissolved air flotation or column flotation.

In the case of column-type flotation cells in which the flotation chamber's diameter is many times less than the height thereof, the distance that a gas bubble has to travel in the suspension or rather the flotation chamber in order to reach the surface of the suspension is particularly great. Because of the particularly long distance involved, particularly large gas bubbles are produced in the suspension, thereby reducing the specific discharge of valuable material particles from the suspension and therefore also the efficiency of the flotation device.

In so-called hybrid flotation cells which are a combination of a pneumatic flotation cell and a column-type flotation cell, particularly larger valuable material particles with diameters in the region of 50 μm or more are not completely bound to the gas bubbles present and can therefore only be partially separated from the suspension. On the other hand, fines with particle diameters in the region of 20 μm or less are particularly well separated.

Although agitator flotation is likewise based on introducing gas bubbles into the flotation process, it is not generally termed a pneumatic flotation method. With this form of flotation, the desired gas bubbles, in particular the desired size distributions of the gas bubbles, are produced by an agitator. Flotation devices suitable for carrying out such a method are therefore termed, among other things, agitator cells.

The above flotation methods are generally carried out using corresponding flotation devices, particularly flotation cells.

For example, for the recovery of ore, e.g. copper ore or molybdenum ore, the extracted ore is ground in an aqueous suspension and pre-treated so that the ore particles to be recovered have surface properties different from those of the unwanted materials. This can be achieved, for example, by selective hydrophobization of the ore particles.

The hydrophobic ore particles are collected by the rising gas bubbles and carried to the surface of the suspension or pulp. The resulting ore particle laden froth is discharged from the flotation device and further processed as required. Such a flotation device is known e.g. from EP 0 560 561 A2.

A high throughput rate with a high yield of valuable material is essential for flotation device profitability in the mining industry. The basic requirement of flotation is that it provides a high throughput while maximizing as far as possible the yield of valuable material to be recovered.

In flotation processes, the yield essentially depends on the flow conditions in the flotation cell and on the homogeneity of the three-phase mixture, i.e. solid, liquid phase and gas phase.

If the flow conditions or mixing conditions are subject to deviations from a desired state, in most cases the yield of the flotation device will be reduced.

Such deviations may be caused by process-related fluctuations in suspension quality and in the volumetric flow rate into the flotation device. These fluctuations can result in e.g. unmixing of the three-phase mixture in the suspension, sedimentation of solids and the creation of unwanted flows. These therefore involve secondary problems such as blocked gas feeds and a yield-impairing flow of suspension in the flotation device, resulting in a significant reduction in yield.

Thus, in U.S. Pat. No. 2,609,097 and U.S. Pat. No. 2,815,859 it has already been proposed to install butterfly dampers in the flotation chamber by means of which the flow behavior of the suspension inside the flotation chamber can be influenced. However, here the influencing possibility is very imprecise and only possible with a considerable time delay, so that once again yield suffers.

U.S. Pat. No. 5,251,764 discloses a flotation machine for separating mineral particles from a suspension, said machine having at least one adjustable guide element with which the available surface area of the suspension in the flotation chamber is selectively reduced. The flow behavior of the suspension and also of the foam product rising therefrom is influenced as a result of the arrangement of such a guide element partially in the suspension and partially amid the foam product. However, the direct contact between foam product and guide element(s) here means that, in the contact region, bubbles of the foam product burst prematurely and the particles bound thereto migrate back into the suspension and cannot be discharged with the foam product as intended. This also adversely affects the yield.

Therefore, no adequate solution has hitherto been found for dealing with undesirable, yield-reducing abnormalities in the flotation process.

The object of the invention is therefore to provide a generic flotation device and a generic method which will reduce or counteract the effects of the abovementioned undesirable variations in the flotation process.

This object is achieved for the flotation device for separating solid particles, in particular of a valuable mineral, from a suspension, comprising
a housing having a flotation chamber,
at least one foam collector for removing a foam product formed in an upper region of the flotation chamber,
at least one feed arrangement for feeding gas and/or suspension into the flotation chamber,
   additionally comprising:
at least one adjustable orifice by which the flotation chamber is subdivided horizontally into an upper section and a lower section and an available inside diameter of the flotation chamber can be locally varied, and which is disposed completely in a suspension region of the flotation chamber,
at least one measuring arrangement for measuring at least one state variable during operation of the flotation device, and
at least one open- and closed-loop control device connected to the at least one measuring arrangement for automatically adjusting the orifice as a function of the at least one state variable.

An orifice of this kind allows the flow of suspension to be controlled automatically and as a function of the at least one state variable such that undesirable flow conditions are counteracted and an improvement in the mixing of the three-phase mixture is achieved.

The at least one orifice is located in the suspension region of the flotation chamber and is not therefore in contact with the foam product floating on the suspension. The suspension region is in the part of the flotation chamber that is filled with suspension, so that the at least one orifice is completely immersed in the suspension, i.e. is disposed completely below the surface of the suspension and is also not in contact with the surface of the suspension. This prevents bubbles of foam product at the boundary layer with the at least one orifice from being destroyed and the output of foam product from being reduced.

The orifice provides a final control element with which rapid intervention and counteraction can be implemented in response to unwanted processes such as flow processes and sedimentation processes during operation of the flotation device.

The essential aspect of the invention is that an orifice-varying adjustment can be made automatically during operation of the flotation device.

Such an orifice solution can be easily retrofitted to existing flotation devices and can help to operate already installed flotation devices with a higher yield for the same or possibly a higher throughput.

The orifice is preferably adjustable in respect of its position, i.e. along a vertical central axis of the flotation chamber and/or of the inclination of the orifice surface and/or of its aperture dimensions.

The orifice setting can be open- or closed-loop controlled as a function of the at least one state variable. A procedure of this kind provides a higher degree of automation for the flotation device or rather for the flotation process, whereby the yield can be increased by faster reaction times.

State variables considered suitable are all the variables or more specifically process parameters having a critical bearing on the flotation process in the flotation device, i.e. in particular those that can contribute to a significant increase or reduction in yield.

It has been found effective to dispose at least one measuring arrangement in the upper section and/or at least one measuring arrangement in the lower section of the flotation chamber in order to measure state variables in the upper section and/or in the lower section of the flotation chamber. It has been found particularly effective here to measure state variables both in the upper section and simultaneously in the lower section of the flotation chamber and adjust the orifice as a function thereof.

The at least one measuring arrangement is preferably designed to measure at least one of the following state variables: suspension density, concentration of solid particles to be separated in the suspension, volumetric gas inflow rate, volumetric flow rate of flotation reagents fed to the suspension, volumetric flow rate of foam product formed, and concentration of solid particles in the foam product.

As each of these parameters can be measured “online” during the flotation process, they are, according to the invention, optimally suitable as state variables as a function of which the associated optimum orifice setting can be simply ascertained and adjusted.

Alternatively or additionally, the foam height or the foam bubble size distribution, for example, can also be used as a state variable. This also provides direct feedback for the effect of the orifice adjustment on the yield.

It has been found particularly effective if the orifice is designed such that the inside diameter of the flotation chamber can be varied locally from an internal wall of the flotation chamber, the orifice being disposed adjacent to the internal wall of the flotation chamber so that there is no gap through which suspension could flow between orifice and internal wall. This prevents undesirable swirling, i.e. undefined flow conditions in the flotation chamber.

A stepless local variation of the inside diameter of the flotation chamber by means of the at least one orifice has been found particularly effective here.

However, the orifice can also be disposed in the flotation chamber such that it is not in direct contact with the internal wall of the flotation chamber.

In an advantageous alternative embodiment, the orifice is ring shaped, in particular circular ring shaped, polygonal ring shaped, truncated hollow cone shaped or truncated hollow pyramid shaped. This enables orifices to be provided in virtually any shape for a large number of flotation device types. Implementation as a tapering truncated hollow body is advantageous, as the orifice additionally produces a collecting effect and causes a diversion of the valuable material or suspension which does not pass directly through the orifice opening, but first strikes the orifice body.

In an advantageous embodiment, the orifice comprises a plurality of orifice elements, the orifice opening being adjustable by movement of the orifice elements. The orifice elements are implemented, for example, as ring segments which are rotatable about a pivot point. The pivot points of the individual ring segments are preferably disposed such that rotation of the ring segments about their pivot point results in a change in the orifice opening diameter. Alternatively, a plurality of flat orifice plates, for example, can be used which are disposed e.g. displaceably and/or rotatably, approximately on the bounding surface, so that the orifice opening can be adjusted by displacement and/or rotation of the orifice plates.

The orifice is preferably implemented as an iris. Surprisingly, it is possible for such an iris to operate even under the kind of harsh conditions prevalent in ore pulp flotation.

It is also advantageous that the orifice elements are inclined in the direction of the lower section of the flotation chamber. On the one hand this reduces flow disturbance in the flotation device. It also counteracts particle accretions on the orifice elements. In addition, simple deflection of solid particles to be recovered is achievable by means of inclined orifice elements. In particular, it is advantageous if the solid material to be recovered is always deflected in the direction of gas-bubble-rich regions of the suspension.

In particular, the flotation device is implemented as a column flotation cell, a pneumatic flotation cell or a hybrid flotation cell. For a definition of these terms, please refer to the introduction.

It has been found effective if, in the upper section of the flotation chamber, a pipe element which subdivides the upper section of the flotation chamber into a middle section and an annular outer section is inserted concentrically to an internal wall of the flotation chamber. In addition, at least one first feed device for feeding gas and suspension into the outer section of the flotation chamber and at least one second feed device for feeding gas into the lower section of the flotation chamber are preferably present. The at least one second feed device is preferably disposed opposite the orifice such that suspension passing through the orifice opening converges with the gas bubbles stream formed. This actively promotes the mixing of solid phase, liquid phase and gas phase by means of the orifice, which helps to provide a high yield. Such an embodiment therefore allows optimum gassing of the suspension in the upper and lower section of the flotation chamber while optimizing the yield.

In particular, the at least one measuring arrangement is here designed to measure at least one of the following as a state variable: volumetric flow rate of foam product formed in the middle section, volumetric flow rate of foam product formed in the outer section, concentration of solid particles in the foam product in the middle section, concentration of solid particles in the foam product in the outer section, foam height of the foam product in the middle section, foam height of the foam product in the outer section, foam bubble size distribution of the foam product in the middle section and foam bubble size distribution of the foam product in the outer section.

According to the invention, the orifice or the individual elements thereof is automatically adjustable by electrical means such as at least one servomotor.

In addition, in order to increase the yield, it has been found effective for the flotation chamber to have a larger inside diameter in the upper section than in the lower section.

Between the upper section and the lower section, a transition region is present, the orifice preferably being disposed within said transition region. The orifice can thus actively influence the flow conditions in the transition region and therefore help to increase the yield. In particular, convective cell flows which carry solid particles away from a gas bubble stream, i.e. counteract the flotation of the solid material, are prevented from forming in the lower section of the flotation chamber.

The flotation device according to the invention can be used in a wide range of technical fields, preferably in the mining industry where ore particles are to be recovered as a valuable material from an ore pulp. Use of the flotation device according to the invention has been found particularly advantageous for the flotation of valuable material particles, particularly ore mineral particles, from a suspension having a solids content ranging from 10 to 60% with the formation of the foam product.

It can also be advantageously used in the paper industry where ink residues are to be removed from a suspension or more specifically a paper pulp, in order to increase the degree of whiteness of the pulp. Other advantageous areas of application are in the field of oil sand processing where in some cases bitumen residues or organic compounds are to be removed from a suspension using a flotation method, or in the field of waste water engineering, e.g. in sewage treatment plants.

The object is achieved in respect of the method part by a method for operating the flotation device according to the invention, comprising the following steps:
feeding suspension and gas into the flotation chamber;
measuring at least one state variable of the flotation device by means of the at least one measuring arrangement; and
transmitting the at least one state variable to the at least one open- and closed-loop control device by means of which the orifice is adjusted as a function of the at least one state variable.

Such a procedure allows unwanted deviations from the desired process behavior to be counteracted quickly and efficiently. This prevents any reduction in the yield from the flotation device caused by such deviations, thereby achieving the object stated above.

The statements made in relation to the flotation device apply analogously to the method.

For this purpose an open- and/or closed-loop control device for the flotation device is preferably provided which has machine-readable program code which includes control commands which cause the open- and/or closed-loop control device to carry out the method according to the invention.

Further advantages of the invention will emerge from an exemplary embodiment which will be explained in greater detail with reference to the schematic drawings in which:

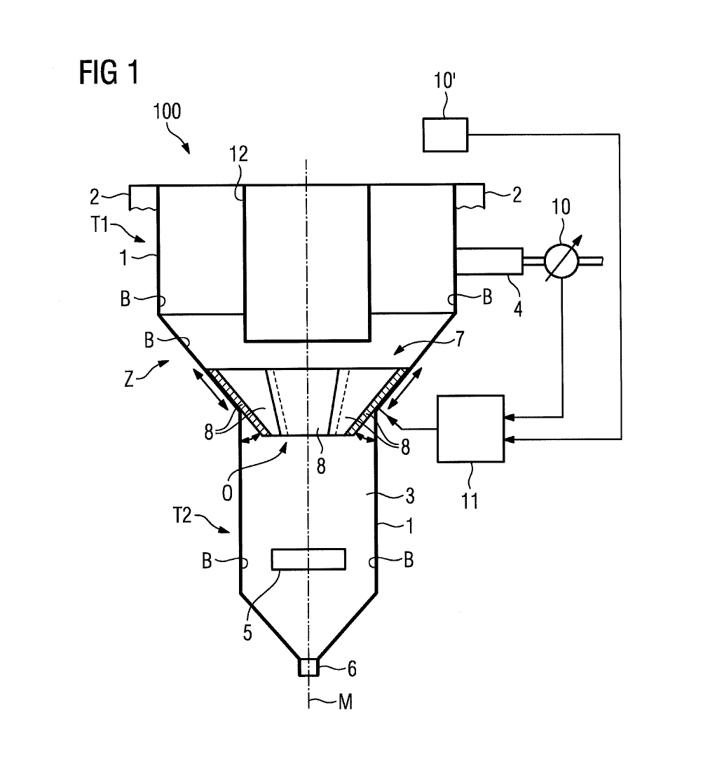

FIG. 1 shows a sectional side view of a flotation device having an orifice,

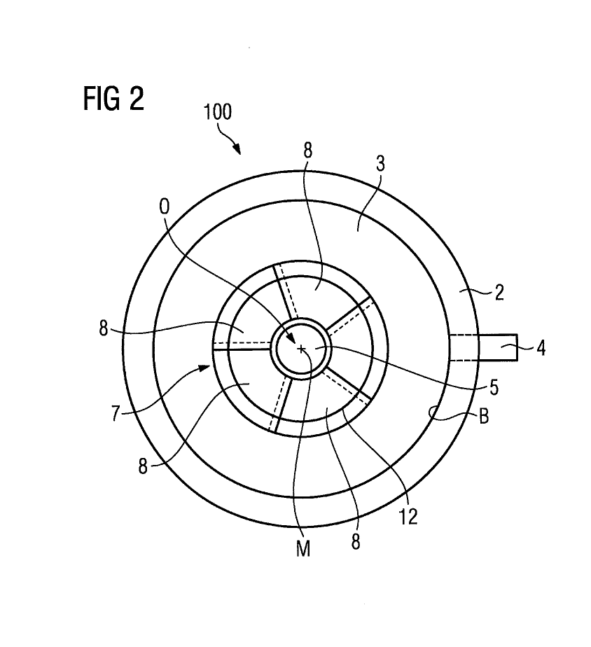

FIG. 2 shows a plan view onto a flotation device with orifice.

A possible embodiment of the flotation device according to the invention will now be explained with reference to a mining industry application. However, as already mentioned above, flotation devices according to the invention can also be used in other technical fields, e.g. in the paper industry, the oil sand industry, the waste water industry and in other industries.

FIG. 1 shows a flotation device 100 implemented as a pneumatic flotation cell for recovering solid particles from ore mineral. The suspension, here known as ore pulp, contains not only solid or valuable material particles but also gangue particles to be discarded.

The flotation device 100 comprises a housing 1. The housing additionally has a flotation chamber 3 for accommodating the suspension. The flotation chamber 3 has an internal wall B on its side facing the suspension or more specifically the ore pulp. Also shown is a vertical axis M of the flotation device 100.

In this example, gasified suspension is fed to the flotation chamber 3 by means of a plurality of first feed devices 4 implemented as ejectors in order to carry out dissolved air flotation.

The valuable material particles contained in the suspension, e.g. of ore, particularly copper ore or molybdenum ore, have been hydrophobized in a pre-treatment step, i.e. they have a hydrophobic surface and can thus attach to gas bubbles in the suspension and be carried upward therewith. Conversely, the gangue particles are hydrophilic and sink to the bottom.

In the example, the ore pulp/gas mixture is injected essentially horizontally into the flotation chamber 3 by means of the first feed devices 4. Preferably four first feed devices 4 or ejectors are used which are offset by 90° in each case, disposed evenly around the circumference of the housing 1.

The gas-laden ore pulp is injected at high pressure into the flotation chamber 3. Because of the high shear rates in the nozzle, the supplied gas is dispersed into small gas bubbles. Due to the pressure drop in the flotation chamber 3, additional gas bubbles are formed which are then likewise used for flotation. This mechanism is known as dissolved air flotation.

The gas introduced with the ore pulp into the flotation chamber 3 forms gas bubbles which rise to the surface of the ore pulp or rather to a boundary layer formed by ore pulp and atmosphere. The gas bubbles themselves are hydrophobic, which means that hydrophobic valuable material particles are attached to the surface thereof. These rise together with the gas bubbles from the ore pulp, and in this example form a valuable-material-containing foam product at the pulp surface. This foam product is removed from the flotation device 100 by means of foam collectors 2 or foam discharge chutes and undergoes further processing. This operation constitutes a first flotation stage of the flotation device 100 shown in FIG. 1.

However, not all the valuable material particles are removed from the ore pulp by means of this first flotation stage, in particular those valuable material particles that sink in a region below the first feed devices 4 or ejectors are not removed. This region is in general completely filled with suspension, i.e. ore pulp, and is here termed the suspension region. In order to still enable such valuable material particles to be recovered, a second flotation stage is provided for this purpose in the present flotation device 100. In the exemplary embodiment, the second flotation stage employs so-called column flotation.

For this purpose, a second feed device 5 implemented e.g. as an aerator for feeding gas is disposed in the lower section T2 of the flotation chamber 3 where a bottom outlet opening 6 for falling hydrophilic solid gangue particles is also provided. This device produces gas bubbles which are suitable for attaching valuable material particles in the lower section T2 of the flotation device 100.

The gas bubbles emerging from the second feed device 5 rise essentially in the central region of the flotation device 100, in particular essentially vertically, and collect in this region the valuable material particles not floated by means of the first flotation stage. In FIG. 1 a pipe element 12 with open end faces is present which subdivides the upper section T1 of the flotation chamber 3 into a middle section and an annular outer section. The gas bubbles of the second flotation stage rise through the middle section to the surface or boundary layer of the suspension. When the gas bubbles laden with valuable material particles reach the surface or boundary layer of the suspension, the resulting foam product is discharged by means of the foam collector 2.

By combining these two flotation stages, a higher yield of valuable material particles from the ore pulp is achieved than in many other types of flotation cell that employ only a single flotation stage within a flotation device.

For flotation, the yield essentially depends on the flow conditions in the flotation chamber and on the homogeneity of the three-phase mixture, i.e. solid, liquid phase and gas phase.

If the flow conditions or mixing conditions are subject to deviations from a desired state, the yield of the flotation device, i.e. the quantity and/or quality of the foam product, will be reduced.

Such deviations may be caused by process-related fluctuations in suspension quality, in the volumetric gas inflow rates and in the volumetric flow rate of suspension into the flotation device. These fluctuations can, for example, result in unmixing of the three-phase mixture in the suspension, sedimentation of solid particles and the creation of undesirable flows. These are generally associated with secondary problems such as blocked gas feeds, and a yield-impairing flow of suspension in the flotation device. This results in a significant reduction in the yield of valuable material particles.

For this reason the flotation device 100 has an orifice 7 having an automatically adjustable orifice opening O. The orifice 7 is located completely in the suspension region of the flotation chamber 3, i.e. it is disposed below the surface of the suspension, i.e. completely within the suspension. In particular, the position of the orifice opening O, possibly of the entire orifice 7, is adjustable in the vertical direction.

This provides a final control element with which corrective action can be taken with respect to the flow in the flotation device 100 in response to changing process conditions and/or disadvantageous flow conditions.

In FIG. 1, the orifice 7 is disposed in a transition region Z between the upper section T1 and lower section T2 of the flotation chamber 3. The flotation chamber 3 has a larger inside diameter in the upper section T1 than in the lower section T2. Dissolved air flotation takes place predominantly in the first section T1 and column flotation predominantly in the second section T2 of the flotation chamber 3.

Especially in the transition region Z, flow instabilities which impact the yield can occur with a combined flotation device 100 of this kind, particularly as the result of external effects.

However, the use of an adjustable orifice 7 is completely independent of the present embodiment of the flotation device 100, as in each flotation device the process conditions and/or flow conditions inside the flotation device have a critical effect on the yield of the material to be recovered.

The orifice 7 comprises a plurality of orifice elements 8. In the exemplary embodiment these are trapezoidally shaped and displaceably disposed in the direction of inclination of the transition region Z. The orifice elements 8 are displaced automatically by means of servomotors (not shown).

The orifice elements 8 are preferably not only displaceable but also rotatable about a predefined pivot point. By combining displacement and rotation of the orifice elements 8, different orifice opening diameters can be steplessly implemented for a fixed orifice opening position in the direction of the central axis M. The pivot point or axis of rotation of an orifice element 8 can preferably be disposed near or on the internal wall B of the flotation chamber 3.

The orifice 7 therefore has an orifice opening O that is automatically adjustable in terms of both its position along the central axis M and its diameter.

The orifice 7 is preferably adjusted on the basis of one or more measured state variables which are present during operation of the flotation device 100 and can be measured. In FIG. 1, two measuring arrangements 10 and 10′ are provided for this purpose.

By means of the measuring arrangement 10′, a state variable is measured which characterizes the output of valuable material particles from the flotation device 100, such as the quality of the foam product constituted by the floating aeroflocs on the boundary layer between ore pulp and atmosphere. The measuring arrangement 10′ is here designed, for example, to measure either the foam height and/or the foam bubble size distribution of the foam product, the total solid particle concentration in the foam product, the concentration of valuable material particles in the foam product or the concentration of barren rock or gangue in the foam product.

With particular preference, in the case of the flotation device 100 shown in FIG. 1 in which the pipe element 12 in the upper section T1 of the flotation chamber 3 subdivides the latter into a middle section and an annular outer section, a volumetric flow rate of foam product formed in the middle section and/or a volumetric flow rate of foam product formed in the outer section is measured. Alternatively or in combination therewith, a concentration of solid particles in the foam product in the middle section and/or a concentration of solid particles in the foam product in the outer section are measured separately. Separate measurement of the foam height and/or foam bubble size distribution in the middle section and outer section has also proved advantageous. This enables good results to be achieved, as separate characterization of the processes in the region of dissolved air flotation and of column flotation is possible.

In addition, as shown in FIG. 1, or alternatively to the measuring arrangement 10′, a different/further state variable such as the density of the suspension, concentration of valuable material particles to be separated in the suspension, total volumetric inflow rate of suspension or volumetric flow rate of gas fed to the suspension by means of the feed devices is measured by means of another measuring arrangement 10.

At least one of the measured state variables, but in particular a plurality thereof in combination, these being measurable in the upper section T1 and/or in the lower section T2 of the flotation chamber 3, is used to adjust the orifice 7.

For this purpose, the measuring arrangement(s) 10 or 10′ used is/are operatively connected to an open- and/or closed-loop control device 11 which determines manipulated variables as a function of the state variables measured and delivers actuating signals to the auxiliary devices (not shown) for adjusting the orifice elements 8. The orifice 7 is then adjusted automatically according to these actuating signals, the orifice opening O being changed or more specifically optimized to suit the process parameters currently obtaining.

To determine the manipulated variables, in some cases physical or empirical models which describe the flotation process can be used. In particular, because of the process dynamics, neural networks can be advantageously applied.

The procedure presented here allows dynamic control of the flotation device 100 with a consistently maximum yield, so that resources used can be optimally utilized.

FIG. 2 shows a plan view of the flotation device 100 depicted in FIG. 1. The orifice 7 visible in the plan view, comprised of the trapezoidal orifice elements 8, has an adjustable orifice opening O. The orifice elements 8 are vertically displaceable in the direction of inclination. This translatory movement contains a radial component by means of which the diameter of the orifice opening O can be adjusted.

Adjacent orifice elements 8 are disposed in an overlapping manner, so that essentially no ore pulp can flow between the adjacent orifice elements 8 or between the internal wall B of the flotation chamber 3 and the orifice elements 8. The orifice 7 is of similar design to an iris, which has been recognized here as a particularly advantageous embodiment, as it allows stepless and particularly accurate adjustment of the orifice diameter.

The overlapping ensures that, even when the orifice opening is enlarged e.g. due to radial displacement of the orifice elements 8 outward, essentially no ore pulp can flow between the adjacent orifice elements 8, thereby preventing disturbance of the flow conditions, such as swirling.

In general, any suitable bodies can be used as orifice elements, e.g. flat or curved plates or ring segment shaped bodies that can be moved in a controlled manner. In particular, the abovementioned irises are used in adapted dimensions.

According to the invention, an automatically adjustable orifice can be installed at any point inside the flotation chamber of any design of flotation device.

In particular, the invention can be used for all known flotation devices both in the field of mining and in the field of the paper industry or waste water engineering, e.g. for sewage treatment plants, etc.

1-15. (canceled)

16. A flotation device to separate solid mineral particles from a suspension, comprising:
a housing having a flotation chamber;
a feed arrangement to feed gas and/or the suspension into the flotation chamber;
an adjustable orifice to subdivide the flotation chamber horizontally into an upper section and a lower section and to locally adjust an available inside diameter of the flotation chamber, the orifice being positioned completely in a suspension region of the flotation chamber;
a foam collector to remove a foam product from the upper section of the flotation chamber;
a measuring unit to measure a state variable during operation of the flotation device; and
a control device connected to the measuring unit to automatically adjust the orifice as a function of the state variable.

17. The flotation device as claimed in claim 16, wherein the measuring unit is positioned in the flotation chamber.

18. The flotation device as claimed in claim 16, wherein the measuring unit measures at least one state variable selected from the group of state variables consisting of suspension density, concentration of solid particles to be separated from the suspension, volumetric gas inflow rate, volumetric flow rate of flotation reagents fed to the suspension, volumetric flow rate of foam product formed, concentration of solid particles in the foam product, foam height of the foam product and foam bubble size distribution of the foam product.

19. The flotation device as claimed in claim 16, wherein
at least one portion of the flotation chamber has a maximum inside diameter defined by an internal wall of the flotation chamber, and
the orifice adjustably reduces the inside diameter of the flotation chamber from the internal wall of the flotation chamber.

20. The flotation device as claimed in claim 19, wherein the orifice is an iris adjustable orifice.

21. The flotation device as claimed in claim 16, wherein the flotation device is a column flotation cell, a pneumatic flotation cell or a hybrid flotation cell.

22. The flotation device as claimed in claim 21, wherein
a pipe element is provided in the upper section of the flotation chamber, concentrically to an internal wall of the flotation chamber, and
the pipe element subdivides the upper section of the flotation chamber into a middle portion and an annular outer portion.

23. The flotation device as claimed in claim 22, wherein the feed arrangement comprises:
a first feed device to feed gas and suspension into the outer portion of the upper section of the flotation chamber, and
a second feed device to feed gas into the lower section of the flotation chamber.

24. The flotation device as claimed in claim 22, wherein the measuring unit measures at least one state variable selected from the group consisting of volumetric flow rate of foam product formed in the middle portion of the upper section of the flotation device, volumetric flow rate of foam product formed in the outer portion of the upper section of the flotation chamber, concentration of solid particles in the foam product in the middle portion of the upper section of the flotation device, concentration of solid particles in the foam product in the outer portion of the upper section of the flotation chamber, foam height of the foam product in the middle portion of the upper section of the flotation device, foam height of the foam product in the outer portion of the upper section of the flotation chamber, foam bubble size distribution of the foam product in the middle portion of the upper section of the flotation device, and foam bubble size distribution of the foam product in the outer portion of the upper section of the flotation chamber.

25. The flotation device as claimed in claim 16, wherein upper section of the flotation chamber has a larger inside diameter than the lower section of the flotation chamber.

26. The flotation device as claimed in claim 16, wherein
the upper section of the flotation chamber has a larger inside diameter than the lower section of the flotation chamber,
the orifice is provided in a transition region of the flotation chamber,
the transition region has an inner wall sloping outward from the lower section of the flotation chamber to the upper section of the flotation chamber,
the suspension region is provided in the transition region and the lower section of the flotation chamber, and
the orifice is formed of iris elements movable along the inside wall of the transition region of the flotation chamber.

27. The flotation device as claimed in claim 16, wherein the control device is an open loop control device.

28. The flotation device as claimed in claim 16, wherein the control device is a closed loop control device.

29. A method for operating a flotation device, comprising:
feeding a suspension and gas into a flotation chamber of the flotation device;
measuring a state variable of the flotation device using a measuring unit;
transmitting the state variable to a control device;
using the control device to locally adjust an available inside diameter of the flotation chamber as a function of the state variable, the orifice being positioned completely in a suspension region of the flotation chamber, the orifice dividing the flotation chamber horizontally into an upper section and a lower section; and
collecting a foam product from the upper section of the flotation chamber.

30. The method as claimed in claim 29, wherein the state variable measured by the measuring unit is at least one state variable selected from the group consisting of suspension density, concentration of solid particles to be separated in the suspension, volumetric gas inflow rate, volumetric flow rate of flotation reagents fed to the suspension, volumetric flow rate of foam product formed, concentration of solid particles in the foam product, foam height of the foam product, and foam bubble particle size distribution of the foam product.

31. The method as claimed in claim 29, wherein
the flotation device is a column flotation cell, a pneumatic flotation cell or a hybrid flotation cell,
a pipe element is provided in the upper section of the flotation chamber, concentrically to an internal wall of the flotation chamber, and
the pipe element subdivides the upper section of the flotation chamber into a middle portion and an annular outer portion.

32. The method as claimed in claim 31, wherein the state variable measured by the measuring unit is at least one state variable selected from the group consisting of volumetric flow rate of foam product formed in the middle portion of the upper section of the flotation device, volumetric flow rate of foam product formed in the outer portion of the upper section of the flotation chamber, concentration of solid particles in the foam product in the middle portion of the upper section of the flotation device, concentration of solid particles in the foam product in the outer portion of the upper section of the flotation chamber, foam height of the foam product in the middle portion of the upper section of the flotation device, foam height of the foam product in the outer portion of the upper section of the flotation chamber, foam bubble size distribution of the foam product in the middle portion of the upper section of the flotation device, and foam bubble size distribution of the foam product in the outer portion of the upper section of the flotation chamber.

33. The method as claimed in claim 29, wherein
the suspension contains ore mineral particles,
the suspension has a solids content ranging from 10 to 60%, and
the flotation devices forms the foam product to separate the ore mineral particles from the suspension.
